(19) United States
(12) Patent Application Publication
(10) Pub. No.: US 2019/0162599 A1
(43) Pub. Date: May 30, 2019

(54) MECHANISM AND METHOD FOR FOCUSING OPTICAL SYSTEM USING GEAR AND TIMING BELT

(71) Applicant: VIETTEL GROUP, Ha Noi City (VN)

(72) Inventors: Hong Nam TA, Ha Noi City (VN); Van Tho NGUYEN, Ha Noi City (VN)

(73) Assignee: VIETTEL GROUP, Ha Noi City (VN)

(21) Appl. No.: 16/202,090

(22) Filed: Nov. 28, 2018

(30) Foreign Application Priority Data
Nov. 29, 2017 (VN) 1-2017-04804

(51) Int. Cl. G01J 5/08; G01J 5/02; G02B 7/10; G02B 7/28

(52) U.S. Cl. CPC G01J 5/0806; G01J 5/0265; G02B 7/28; G02B 7/10; G01J 5/0205

(57) ABSTRACT

The invention proposes a mechanism and method of focusing for optical systems by gear and timing belt. In particular, the focusing mechanism for the optical system by gear and timing belt consists of the following components: the optical front cover module (including the first lens element, the middle lens element, the mechanical of front cover); The optical rear cover module (including last lens element, mechanical of rear cover); The focusing mechanism (including adjustment ring, radial shaft seal, transmission shaft, timing pulley, timing belt, ball bearing, large gear); The protection and mounting mechanical system (including mechanical protection cover, internal mounting mechanical system). The method of focusing for the optical system by mean of gear and timing belt consists of the following steps: Step 1: Integrating the mechanism into the mechanical of the system; Step 2: Adjusting the final lens element; Step 3: Identifying the most convergent position of the optical system.

### BACKGROUND OF THE INVENTION

The invention relates to a mechanism and method for focusing fixed focal length infrared optical system by means of gear and timing belt. Specifically, the mechanism and focusing method for the optical system mentioned in this invention makes it possible to adjust the system convergence point in a simple and efficient manner using a mechanism actuated by gear and timing belt.

The optical system normally include one or more lens elements held by a mechanical assembly. Based on the design, if the focal length of optical system can be varied, it's called zoom lens, and if not, it's called fixed focal length lens. However, in the operation process, both zoom lens and fixed focal length lens need to adjust the lens elements position to focus the beam light on the sensor plane when the operation environment temperature changes. The reason is, when the environment temperature varies, the characteristics of the lens material are changed. It creates changes in the optical system parameters and therefore, the convergence point of the beam is out of the sensor plane. It's called defocus aberration. Therefore, the focusing process is required to adjust the beam convergence point back to the sensor plane by using a special mechanical assembly. This mechanical assembly is called focusing mechanism.

Thermal infrared handheld opto-electronic devices are the combination of optical technology and electronic technology, enabling the scene to be captured by imaging sensors to create output digital images, so that these images can be compressed, stored, transmitted, or processed by image processing algorithms to improve the efficiency for observation. Some devices also integrate the advanced features such as object detection, classification, identification, and positioning, etc. However, because of including the electronic components, these devices are housed in a high requirement tightness mechanical housing to protect the electronic circuits and optical elements from the operating environment factors such as water, dust, humidity, vibration, shock, etc. It is different from the traditional optical devices only having optical components so that the protection is much easier and more convenient.

As mention above, since the optical system always need to adjust the lens elements position, the tight mechanical housing not only protects the system elements but also makes it difficult to adjust the focal length of system. The following are three main solutions for focusing adjustment in a thermal infrared optical system:

Athermalized Lens Design:

The athermalization technology is normally applied for fixed focal length lens. In this optical system, the heating compensation components are added in order to compensate the environment temperature variation. However, it may increase the cost of product and does not completely resolve the defocus phenomenon. Another problem of athermalized lens is the limitation of observation range which is determined by H/2 distance where H is hyperfocal distance of optical system. For example, a lens system has focal length of 60 mm and F#1.0 will have the hyperfocal distance about 106 m to infinity (∞). That means, at the distance from 0 m to 106 m close to device, we cannot see an object clearly.

Auto Focus Lens Design:

Another technology is to use auto-focus module which includes one or more sensors, motor and controller system to automatically calculate and move single or a group of lens elements of the optical system to focus the beam on the image sensor plane when the parameters of system or environment are changed. It's normally used in zoom lens system where the focal length of the system can be varied. However, this mechanism requires complex technology which is the combination of the specific focus sensor, processing engine, motor and driver. It increases the cost, power consumption and the size of system which is not suitable for a handheld device requirements such as compact, small and low power consumption. Therefore, the auto-focus system is normally used for the base station system fixed in the ground, vehicle or the remote surveillance system

Manual Focus Lens Design:

A third solution is manual focusing mechanism in which the focus sensor is replaced by human eyes. In the manual focus design, the optical system does not need focus sensor or compensation components. Instead of that, human adjust the system directly via mechanical mechanism and sense the image quality by human eyes. As it's required to manipulate manually, optical systems usually have to be designed with a adjustable component outside the mechanical housing. Normally, this component is the first element of the lens system. However, it's difficult for tightness and impact resistance to protect the optical system in this case. In addition, adjusting the optical focus by moving the first element of the optical system is not the optimum solution to obtain the best image quality (commonly they move the final lens element).

Basing on the existing problems above, we've proposed a mechanism and method to manually adjust the focus of the optical system to ensure the tightness of the equipment which is suitable for a portable device such as thermal infrared handheld devices.

### SUMMARY OF THE INVENTION

The first purpose of the invention is to propose a focusing mechanism for the optical system by means of a gear and a timing belt that solves the limitations of the existing methods. The advantages of the proposed mechanism are: Ensuring the tightness of the mechanical housing; Keeping the optical system inside the mechanical housing and therefore ensuring the safety of the optical system; Ensuring the best quality of obtained image by allowing user to adjust the final lens element of the optical system when performing the focusing process.

### KEY TECHNICAL FEATURES

To implement this, the focus mechanism for the optical system by gear and timing belt is used. It consists of the following components: the front cover of optical system (which includes the first lens element, the middle lens element and the front mechanical cover); The rear cover of optical system (including the last lens element and the rear mechanical cover); the focusing mechanism (including the adjustment ring, radial shaft seal, transmission shaft, timing belt, timing pulley, large gear and the ball bearing), the protection and mounting mechanical system (including the mechanical protection cover and the internal mechanical mounting).

The second purpose of the invention is to propose a method of focusing for optical systems by means of gear and timing belt, including the three main steps: Step 1: Integrating the focusing mechanism into the mechanical mounting; Step 2: Adjusting the last lens element using focusing mechanism; Step 3: Identify the most convergent position of the optical system.

The proposed mechanism and method of focusing allow us to adjust last lens element in an indirect way, therefore, the optical system can be placed in a tight mechanical housing.

### BRIEF DESCRIPTION OF THE DRAWINGS

FIG. 1: The overall view of the focusing mechanism for the optical system using gear and timing belt.

FIG. 2: Internal structure for the optical system using gear and timing belt.

FIG. 3: Principle of convergence point adjustment of three-element optical lens system (1), (2), (4).

FIG. 4: Focusing mechanism of the optical system after being attached to the outer mechanical protection and internal mechanical mounting.

FIG. 5: Diagram of the focusing method for optical systems using gear and timing belt.

### DETAILED DESCRIPTION OF THE PREFERRED EMBODIMENT

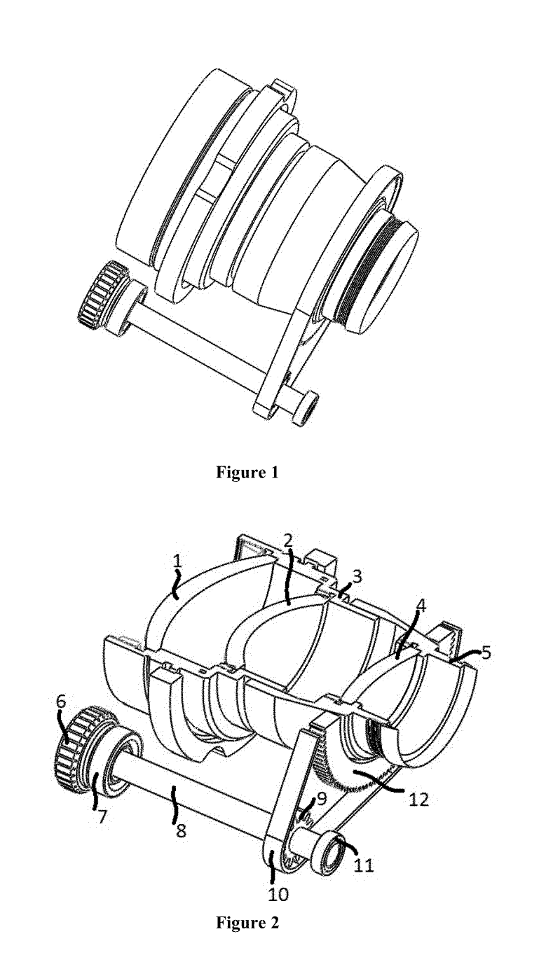

The focusing mechanism for optical system using gear and timing belt is depicted in FIGS. 1, 2 and 4, including: The optical front cover module; The optical rear cover module; The focusing mechanism and the protection and mounting mechanical.

It is described in detail as below:
The optical front cover module: This is the fixed component of the optical system, consisting of one or several fixed lens which are mounted on the lens mechanical housing. These lens elements are optical alignment. The optic front cover is an immobile component during the focusing adjustment process. The main components of the optic front cover include:
First lens element (1): The element that is outside of the optical system, where light from the outside environment enters the optical system. With the infrared lens, the first lens is usually made of infrared material such as Ge, GaAs and using spherical, aspherical or diffraction surfaces, coated with DLC coating to ensure rigidity, avoiding scratches from the external environment. The first lens element are mounted to front cover mechanical (3). At the conjunction of first lens element (1) and the mechanical (3), the optical glue like UV is used to fix and protect the optical system from the invasion of environment factors such as dust, water or humidity.
Middle lens element (2): The second lens element in the optical system, mounted on the same mechanical (3) and optically aligned to the first lens element (1). Depending on the design of optical system, the middle lens may be required or not. This element adjusts the beam of light after passing through the first lens element (1) with the correct amount of adjustment before moving to the last lens. The surface of the middle element can be spherical or aspherical depending on the design of each optical system.
The front cover mechanical (3) is the fixed component and keeps the first lens element (1) and middle lens element (2) aligned in a constant distance.
Optical rear cover module: A moving component in the optical system, consists of the last lens element which is mounted on rear cover mechanical. The rear cover mechanical can be rotated and aligned with the front cover mechanical (3). The optical rear cover module consists of the following components:
The last lens element (4): The last lens element of the optical system, in front of the image sensor, which converges the light coming from the middle lens (2) on the sensor plane. In the infrared optics system, this component usually has an aspheric or diffraction surface and is covered with AR coating.
Rear cover mechanical (5): The mechanical component is responsible for holding the last lens element (4). It can be translated and rotated on axis with the front cover mechanical (3). When the rear cover mechanical (5) rotates around the front cover mechanical (3), the lens element (1), (2) and (4) are always aligned in a straight line of optical axis and the last lens will translationally move forward or backward to the lens (1) and (2) depend on the direction rotation of the front and rear cover mechanical.
Focusing mechanism: It consists of actuator that transfers the motion from the outer adjustment ring into the translational motion between the first lens element (1), the middle lens element (2) and the last lens element (4) of the optical system to adjust the focus of the beam light on the sensor plane. It consists of the following components:
Adjustment ring (6): The metal, circular shape component with rough surface. When user rotates this component, it will transfer the motion to the other component of focusing mechanism to shift the convergence point of the optical system.
Radial shaft seal (7): Performing the intermediate junction between the transmission shaft (8) and the protection mechanical of the system (13). The role of the shaft seal (8) is to enable the rotary motion transmission while maintaining the tightness of the mechanical housing.
Transmission shaft (8): Transmission between the adjustment ring (6) to the timing pulley (9) and ball bearing (11). The transmission shaft (8) is fixed and aligned to the radial shaft seal (7) and ball bearing (11). The shaft seal (7) and timing pulley (11) will be attached to the protection mechanical (13) and mounting mechanical (14).
Timing pulley (9): Attached to the transmission shaft (8), to transfer the transmission from the transmission shaft (8) to the large gear (12) via the timing belt (10).
Timing belt (10): Making the connection between the timing pulley (9) and the large gear (12). Then transferring the transmission from the transmission shaft (8) to the mechanical rear cover (5). It is selected for space saving, easy integration (due to the easy adjustment of belt) and requires a lower impact force.
Ball bearing (11): Keep the transmission shaft (8) and is aligned with the radial shaft seal (7).
Big gear (12): fixed to the mechanical rear cover (5), the tooth pitch corresponding to the timing belt (10) and timing pulley (9) pitch size. Its role is to transmit the movement from the timing belt (10) to the mechanical rear cover (5) to allow the rear cover module to rotate around the front cover module (3) and the last lens element (4) can translationally move backward or forward to the first lens element (1) and middle lens element (2)

Protection and Mounting Mechanical System:
Protection mechanical housing (13): The mechanical component that protects the entire optical system to avoid the impact of external environment.
Mounting mechanical component (14): Is the mounting mechanical of system, which is designed with solid metal material, which serves as a support for the rear of optical system as well as for the transmission shaft (8).

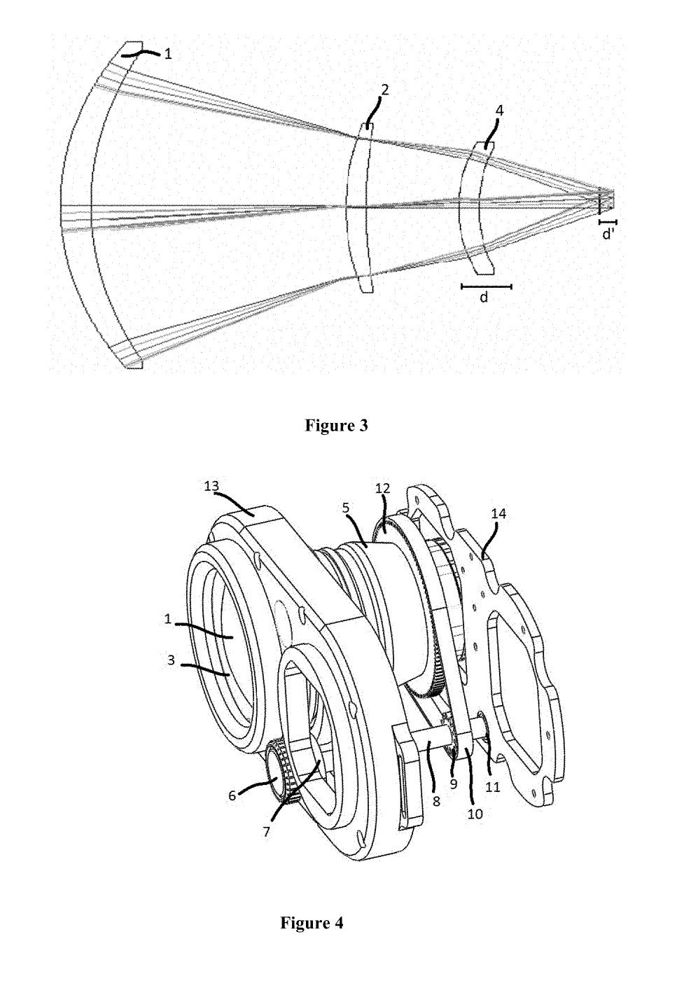

With the components above, the focusing mechanism for the optical system using gear and timing belt is designed to adjust the distance between the last lens element (4) and the fixed lens element (1) and (2). Therefore, the convergence point of the beam light can be changed to focus on the sensor plane. This displacement is described in FIG. 3. When the last lens element (4) moves within the displacement range d, then the convergence point of the beam will move within about d′.

Therefore, if the sensor is placed in the distance d′, then we always find a position of the last lens element (4) with the displacement range d so that the beam is most convergent. When the last lens element (4) moves to the left of d, the convergence point of the optical system moves to the left of d′ and when the last lens element (4) moves to the right of d, the convergence point will shift to the right of d′. The focusing mechanism mentioned in this invention is designed to make this method of focusing adjustment more simple and effective.

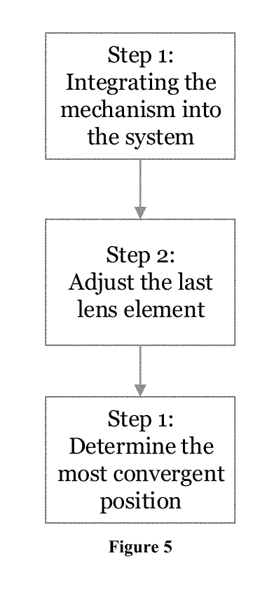

The method is shown in FIG. 5, which consists of the following steps:

Step 1: Integrating the Mechanism into the System Mechanical

To integrate the focusing mechanism for the optical system using gear and timing belt into the system mechanical, we use the radial shaft seal (7) and ball bearing (11). The radial shaft seal (7) is usually mounted on the mechanical enclosure of the system, in which the air tightness, water resistance and dust resistance are required. Referring to FIG. 4, the radial shaft seal (7) is attached to the protection mechanical component (13) while the ball bearing (11) is attached to the inner mechanical mounting component (14). Radial shaft seal (7) and ball bearing (11) are aligned to ensure the stable transmission of shaft (8).

Step 2: Adjusting the Last Lens Element Using Proposed Focusing Mechanism

To adjust the last lens element (4) to the right of d, the user rotates the adjustment ring (6) clockwise, then the movement of the adjustment ring (6) will be driven through the transmission shaft (8), the timing pulley (9), the timing belt (10), the large gear (12) to make the mechanical rear cover component (5) rotate in the same direction. An actuator mechanism between the front cover module (3) and the rear cover module (5) will cause the last lens element (4) moving towards the middle lens (2) while still ensuring the alignment between both of them. In opposite way, to adjust the last lens element (4) to shift to the left of d, user rotates the adjustment ring (6) counterclockwise, then the last lens element (4) moves far away from the first lens element (1) and the middle lens element (2) in the same principal above.

Step 3: Determining the Convergent Point of the Optical System

Based on the output image of the image sensor located behind the optical system, user can determine the most convergent point of the optical system which he or she can feel the best image quality. After that, the lens system is convergent and the device can be use as expectation.

The invention is described in detail using the mechanism above. However, the person of ordinary skill in the field of invention is not limited to the method described in the description. The invention may be carried out in a modified or altered mode that is not outside the scope of the invention as defined by the claims. Therefore, what is described in the patent description is for illustration only, and will not impose any limitations on the invention.

What is claimed is:

1. The focusing mechanism for the optical system by gear and timing belt comprising the following components:
An optical front cover module;
An optical rear cover module;
A focusing mechanism;
A protection and mounting mechanical system, each components is demonstrated as follows:
The optical front cover module comprises of one or several fixed lenses element mounted on the mechanical housing; the lens element are optically aligned; the optical front cover module is immobile in the focus adjustment process including the first lens element, the middle lens element and mechanical of front cover;
The optical rear cover module comprises a last lens element mounted in mechanical of rear cover module and optically aligned with the lens elements of front cover module, the mechanical component which hold the last lens element and a large gear for motion transmission;
A focusing mechanism consists of an actuator that transfers the motion from the an adjustment ring to the translational motion between the lens elements of the optical system and adjusts the focus of the beam light on a sensor plane, thereby providing focusing features for the system and the focusing mechanism, including: an adjustment ring, a radial shaft seal, a transmission shaft, a timing pulley, a timing belt, a ball bearing and a large gear;
A protection and mounting mechanical system: Including a protection mechanical cover, an inner mechanical mounting inside to mount and fix the components of optical system as well as a focusing mechanism and also protect the system from the effect of outer environment.

2. The focusing mechanism for the optical system using gear and timing belt in accordance with claim 1 has an optical front cover module, including:
The first lens element is the outermost part of the optical system, in which the light from the outside enters the optical system;
The middle lens element is responsible for adjusting the path of beam light after passing through the first lens with the correct amount of adjustment;
The mechanical of front cover keeps the first lens element and the middle lens element in a constant distance and optically aligned together.

3. The focusing mechanism for the optical system by gear and timing belt in accordance with claim 1 has an optical rear cover module, including:
The last lens element that converts the beam light coming from the middle lens element and the first lens element onto the sensor plane;
Mechanical of the rear cover module is responsible for mounting and fixing the last lens element and conjunction with the mechanical of front cover.

4. The focusing mechanism for the optical system by gear and timing belt according to claim 1, having a focusing mechanism comprising:
The adjustment ring is used by user to transfer the motion outside to the last lens element inside the tight mechanical of device;
The radial shaft seal enables the rotary motion transmission while maintaining the tightness of the mechanical housing;
The transmission shaft has the role of transmitting the motion from the adjustment ring to the rear cover module of optical system via timing pulley and timing belt;
The timing pulley transmits the motion from the transmission shaft to the large gears via the timing belt;
The timing belt connects the timing pulley and the large gear and transmits the motion from transmission shaft to the rear cover mechanical;
The ball bearing keeps the transmission shaft and axis-aligned with the radial shaft seal;
The large gear is used to transmit motion from the timing belt to the mechanical of the rear cover module to help rear cover module rotate around the front cover.

5. The focusing mechanism for the optical system by gear and timing belt in accordance with claim 1, has the protection and mounting system, including:
The protection mechanical housing that protects the optical system from the outer environment effect;
The mounting mechanical component is designed to hold and fix the optical system for axis-alignment inside the device and to position the transmission shaft from the focus ring.

6. A focus method for optical system by gear and timing belt, including the following steps:
STEP. 1: integrating the mechanism into the mechanical of optical system; At this step, the mechanism includes an adjustment ring, a radial shaft seal, a transmission shaft, a timing pulley and a timing belt that are integrated to a mechanical housing and the optical system;
STEP. 2: Adjusting the last lens element; This step has the function of finding the convergence point of the optical system; And
STEP. 3: Determining the most convergent position of the optical system; This step has the function of locating the highest quality of the output digital image.

7. The focusing method for the optical system by gear and timing belt in accordance with claim 6 wherein the last lens element in the optical system is adjusted indirectly; By this way, it can be used for handheld electro-optical devices that have an optical system housed in an enclosed mechanical enclosure that is difficult to adjust directly.
